(19) United States
(12) Patent Application Publication
(10) Pub. No.: US 2025/0267550 A1
(43) Pub. Date: Aug. 21, 2025

(54) METHOD AND DEVICE FOR PROVIDING USER GROUP-BASED SERVICE IN HETEROGENEOUS SYSTEMS

(71) Applicant: Samsung Electronics Co., Ltd., Gyeonggi-do (KR)

(72) Inventors: Dongeun SUH, Gyeonggi-do (KR); Jungshin PARK, Gyeonggi-do (KR); Youngkyo BAEK, Gyeonggi-do (KR); Hoyeon LEE, Gyeonggi-do (KR)

(21) Appl. No.: 19/053,764

(22) Filed: Feb. 14, 2025

(30) Foreign Application Priority Data
Feb. 15, 2024 (KR) 10-2024-0022180
Mar. 22, 2024 (KR) 10-2024-0039888

(51) Int. Cl. H04W 48/02; H04W 24/10; H04W 48/08

(52) U.S. Cl. CPC H04W 48/02; H04W 24/10; H04W 48/08

(57) ABSTRACT

The disclosure relates to a 5G or 6G communication system for supporting a higher data transmission rate. A method of a user equipment (UE) in a wireless communication system is provided. Configuration information for acquiring system information (SI) of a closed access group (CAG) cell of a gnodeB (gNB) is received from an evolved node B (eNB). A system information block (SIB) is received from the CAG cell. A measurement report including information related to an identifier (ID) of the CAG cell is transmitted to the eNB based on the SIB.

### CROSS-REFERENCE TO RELATED APPLICATION(S)

This application is based on and claims priority under 35 U.S.C. 119(a) to Korean Patent Application Nos. 10-2024-0022180 and 10-2024-0039888, which were filed on Feb. 15, 2024, and Mar. 22, 2024, respectively, in the Korean Intellectual Property Office, the disclosures of which are incorporated herein by reference in their entirety.

### BACKGROUND

### 1. Field

The disclosure relates generally to a method and a device for providing a user group-based service in heterogeneous systems.

### 2. Description of Related Art

5^{th} Generation (5G) mobile communication technologies define broad frequency bands such that high transmission rates and new services are possible, and can be implemented not only in “sub 6 GHz” bands such as 3.5 gigahertz (GHz), but also in “above 6 GHz” bands referred to as millimeter wave (mmWave) including 28 GHz and 39 GHz. In addition, it has been considered to implement 6G mobile communication technologies (also referred to as beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

At the onset of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input-multiple output (MIMO) for mitigating radio-wave path loss and increasing radio-wave transmission distances in mmWave, supporting numerologies (e.g., operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer-2 (L2) pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio-unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure provides a method and a device for providing a user group-based service in heterogeneous systems.

According to an aspect of the disclosure, a method of a UE in a wireless communication system is provided. The method may include: receiving, from an evolved node B (eNB), configuration information for acquiring system information (SI) of a closed access group (CAG) cell of a gnodeB (gNB), receiving, from the CAG cell, a system information block (SIB), and transmitting, to the eNB, a measurement report including information related to an identifier (ID) of the CAG cell based on the SIB.

The information related to the ID of the CAG cell may include at least one of a CAG ID of the CAG cell or a mapped closed subscriber group (CSG) ID corresponding to the CAG.

The method may further include acquiring the CAG ID or the mapped CSG ID based on at least one of mapping information between the CAG ID and the CSG ID or a mapping rule for deriving the mapped CSG ID from the CAG ID.

The method may further include identifying whether the CAG cell is allowed for the UE based on the CAG ID or the mapped CSG ID based on an allowed CAG list including an allowed CAG ID. The measurement report may include an indication indicating whether the CAG cell is allowed for the UE.

The CAG cell may be discovered by a cell search procedure of the UE.

According to an embodiment of the disclosure, a method of an access and mobility management function (AMF) entity in a wireless communication system is provided. The method may include: receiving, from a mobility management entity (MME), a forward relocation request message including a CAG ID for a CAG cell of a gNB in a source to target transparent container, and performing an access control based on the CAG ID.

The performing of the access control may include identifying whether the CAG ID is included in an allowed CAG list. The allowed CAG list may be included in subscription information.

The method may further include performing handover in case that the CAG ID is included in the allowed CAG list.

The method may further include updating an allowed CAG list of a UE by including the CAG ID, and transmitting, to a unified data management (UDM) module, a subscription information update message including the updated allowed CAG list.

The method may further include transmitting, to a UE, at least one of mapping information between the CAG ID and a mapped CSG ID or a mapping rule for deriving a mapped CSG ID from the CAG ID.

According to an aspect of the disclosure, a UE in a wireless communication system is provided. The UE may include a transceiver; and at least one controller coupled with the transceiver. The at least one controller may be configured to: receive, from a serving eNB, configuration information for acquiring SI of a CAG cell of a gNB, receive, from the CAG cell, an SIB, and transmit, to the eNB, a measurement report including information related to an ID of the CAG cell based on the SIB.

The information related to the ID of the CAG cell may include at least one of a CAG ID of the CAG cell or a mapped CSG ID corresponding to the CAG.

The at least one controller may be further configured to acquire the CAG ID or the mapped CSG ID based on at least one of mapping information between the CAG ID and the CSG ID or a mapping rule for deriving the mapped CSG ID from the CAG ID.

The at least one controller may be further configured to identify whether the CAG cell is allowed for the UE based on the CAG ID or the mapped CSG ID based on an allowed CAG list including an allowed CAG ID. The measurement report may include an indication indicating whether the CAG cell is allowed for the UE.

The CAG cell may be discovered by a cell search procedure of the UE.

According to an aspect of the disclosure, an AMF entity in a wireless communication system is provided. The AMF entity may include a transceiver; and at least one controller coupled with the transceiver. The at least one controller may be configured to: receive, from an MME, a forward relocation request message including a CAG) ID for a CAG cell of a gNB in a source to target transparent container, and perform an access control based on the CAG ID.

The at least one controller may be further configured to identify whether the CAG ID is included in an allowed CAG list. The allowed CAG list may be included in subscription information.

The at least one controller may be further configured to perform handover in case that the CAG ID is included in the allowed CAG list.

The at least one controller may be further configured to update an allowed CAG list of a UE by including the CAG ID, and transmit, to a UDM module, a subscription information update message including the updated allowed CAG list.

The at least one controller may be further configured to transmit, to a UE, at least one of mapping information between the CAG ID and a CSG ID or a mapping rule for deriving the mapped CSG ID from the CAG ID.

Embodiments set forth herein provide a device and a method capable of effectively providing services in a wireless communication system.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of a 5G system, according to an embodiment;

FIG. 2 is a diagram illustrating a method of, when a UE moves from an evolved packet system (EPS) to a 5G system (5GS), updating an allowed CAG list of the UE, according to an embodiment;

FIG. 3 is a diagram illustrating a method of, when a UE performs a handover from an EPS to a 5GS, selecting a target CAG cell supporting one or more of CAG IDs allowed to the UE, based on mapping information between a CSG ID and a CAG ID, according to an embodiment;

FIG. 4 is a diagram illustrating a method of performing an access control, based on a CAG ID of a target base station when a UE performs a handover from an EPS to a 5GS, according to an embodiment;

FIG. 5 is a diagram illustrating a registration procedure of a UE, according to an embodiment;

FIG. 6 is a diagram illustrating a structure of a UE, according to an embodiment; and

FIG. 7 is a diagram illustrating a structure of a network entity, according to an embodiment.

### DETAILED DESCRIPTION

Hereinafter, the operation principle of the disclosure will be described in detail in conjunction with the accompanying drawings. In the following description of the disclosure, a detailed description of known functions or configurations incorporated herein will be omitted when it is determined that the description may make the subject matter of the disclosure unnecessarily unclear. Further, the terms described below are terms defined in consideration of functions in the disclosure. They may be different according to users, intentions of the users, or customs, and therefore, the definitions of the terms should be made based on the contents throughout the specification.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the present disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals may indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Herein, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

A description of known functions or configurations incorporated herein will be omitted when it is determined that the description may make the subject matter of the disclosure unnecessarily unclear. Hereinafter, embodiments of the disclosure will be described with reference to the accompanying drawings.

Herein, terms referring to network entities or network functions (NFs) and entities of edge computing systems, terms referring to messages, terms referring to identification information, and the like are illustratively used for the convenience of description. Therefore, the disclosure is not limited by the terms as described below, and other terms referring to subjects having equivalent technical meanings may also be used.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. In particular, the disclosure may be applied to 3GPP NR (5G mobile communication standard). In addition, embodiments may also be applied to other communication systems having similar technical backgrounds or channel types. In addition, based on determinations by those skilled in the art, embodiments may be applied to other communication systems through some modifications without significantly departing from the scope of the disclosure.

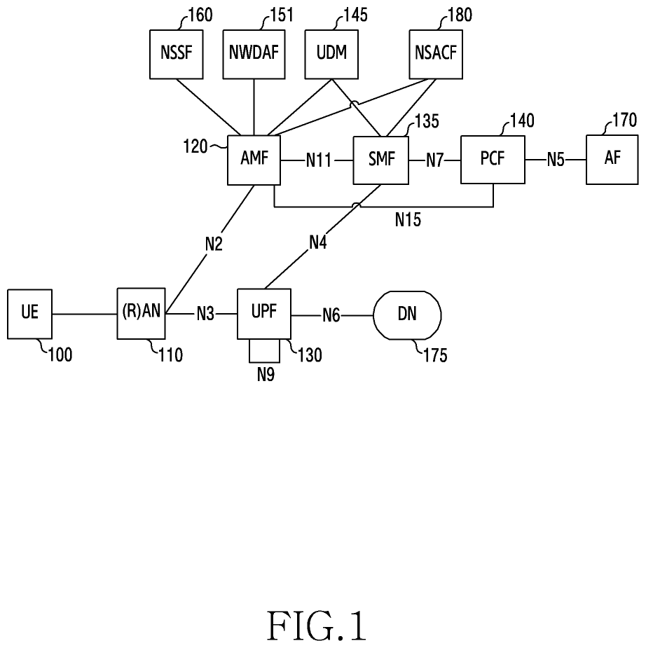

FIG. 1 is a diagram illustrating a structure of a 5G system, according to an embodiment.

A 5G mobile communication network may include a 5G UE (terminal) 100, a 5G radio access network (RAN, a base station (BS), a gNB, an eNB, etc.) 110, and a 5G core network. The 5G core network may include NFs, such as an AMF 120 that provides a mobility management function of the UE, a session management function (SMF) 135 that provides an SMF, a user plane function (UPF) 130 that performs a data transfer role, a policy control function (PCF) 140 that provides a policy control function, a UDM module 145 that provides a function of managing data, such as subscriber data and policy control data, or a unified data repository (UDR) that stores data of various NFs such as the UDM module. The 5G core network may further include NFs, such as a network slice selection function (NSSF) 160, a network data analytic function (NWDAF) 151, an application function (AF) 170, a data network (DN) 175, and a network slice admission control function (NSACF) 180.

Referring to FIG. 1, the UE 100 may perform communication through a wireless channel, that is, an access network, which is established between the UE and a base station (e.g., eNB or gNB). The UE 100 is a device used by a user, and may be a device configured to provide a user interface (UI). For example, the UE 100 may be a UE equipped in a vehicle for driving. The UE 100 may be an autonomous vehicle or a device that performs machine type communication (MTC) operated without the user's involvement. The UE may also be referred to as an electronic device, a terminal, a vehicle terminal, a mobile station, a subscriber station, a remote terminal, a wireless terminal, a user device, or other terms having a technical meaning equivalent thereto. As a UE device, a customer-premises equipment (CPE) or a dongle-type UE may be used as well as a UE. The CPE may be connected to an NG-RAN node like a UE, and provide a network to other communication equipment (e.g., laptop).

Referring to FIG. 1, the AMF 150 may provide a function for access and mobility management in a unit of the UE 100, and one UE 100 may be connected to one AMF 150. Specifically, the AMF 150 may perform at least one function among signaling between core network nodes for mobility between 3GPP access networks, an interface (N2 interface) with the RAN (e.g., 5G RAN) 120, NAS signaling with the UE 100, identification of the SMF 160, and provision of transfer of a session management (SM) message between the UE 100 and the SMF 160. Some or all functions of the AMF 150 may be supported in a single instance of one AMF 150.

Referring to FIG. 1, the SMF 135 may provide an SMF, and when the UE 100 has multiple sessions, each session may be managed by a different SMF 135. Specifically, the SMF 135 may perform at least one function among SM (e.g., session establishment, modification, and release with tunnel maintenance between the UPF 130 and an access network node), selection and control of a user plane (UP) function, configuration of traffic steering for routing traffic from the UPE 130 to a proper destination, an endpoint of an SM part of a NAS message, downlink data notification (DDN), and an initiator of AN-specific SM information (e.g., transfer to the access network through an N2 interface via the AMF 120). Some or all functions of the SMF 135 may be supported in a single instance of one SMF 135.

In 3GPP systems, conceptual links connecting NFs in the 5G system may be referred to as reference points. The reference points may also be referred to as interfaces. The reference points of the 5G system architecture may include:
N1: a reference point between the UE 100 and the AMF 120;
N2: a reference point between the (R) AN 110 and the AMF 120;
N3: a reference point between the (R) AN 110 and the UPF 130;
N4: a reference point between the SMF 135 and the UPF 130;
N5: a reference point between the PCF 140 and the AF 170;
N6: a reference point between the UPF 130 and the DN 175;
N7: a reference point between the SMF 135 and the PCF 140;
N8: a reference point between the UDM module 145 and the AMF 120;
N9: a reference point between two core UPFs 130;
N10: a reference point between the UDM module 145 and the SMF 135;
N11: a reference point between the AMF 120 and the SMF 135;
N12: a reference point between the AMF 120 and an authentication server function (AUSF);
N13: a reference point between the UDM module 145 and the AUSF;
N14: a reference point between two AMFs 120; and
N15: a reference point between the PCF 140 and the AMF 120 for a non-roaming scenario, and a reference point between the PCF 180 in a visited network and the AMF 120 for a roaming scenario.

In the 5G system, network slicing refers to a structure and a technology enabling multiple independent logical networks virtualized in a single physical network. In order to satisfy specialized requirements of a service/application, a network operator provides a service by configuring a virtual end-to-end network referred to as a network slice. In this case, the network slice is distinguished by an identifier referred to as single-network slice selection assistance information (S-NSSAI). The network transmits a set of allowed slices (e.g., allowed NSSAI(s)) to a UE during a UE registration procedure, and the UE transmits and receives application data via a protocol data unit (PDU) session generated via one piece of S-NSSAI (i.e., network slice) in the set of allowed slices.

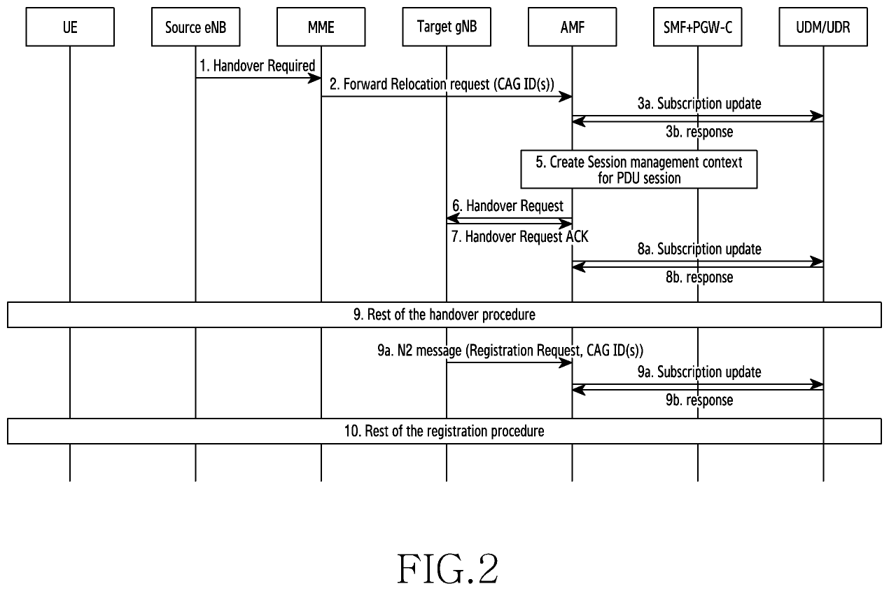

FIG. 2 is a diagram illustrating a method of, when a UE moves from an EPS to a 5GS, updating an allowed CAG list of the UE, according to an embodiment.

More specifically, a processing method of a case where in a handover procedure from an EPS to a 5GS, a target cell is a CAG cell and there is no information on allowance of the UE for the CAG cell in the 5GS is illustrated.

Step 1. A source eNB may transmit a handover required message including a source to target transparent container, a cell ID, and a TAI to an MME.

The source eNB may, if a CAG ID(s) (or CSG ID) for a target cell is obtained, transmit the ID after directly including the ID in the handover required message or including the ID in a separate transparent container.

Step 2. The MME may transmit a forward relocation request message to a target AMF. The forward relocation request message may include MME UE context, a source to target transparent container, a transparent container or CAG ID(s), a cell ID (e.g., a target gNB identity), or a target TAI.

If the MME receives a transparent container in step 1, corresponding information may be included in the forward relocation request message.

In addition, if the MME receives a CAG ID(s) in step 1, corresponding information may be included in the forward relocation request message.

The initial AMF may convert the received MME UE context into 5GS UE context.

The initial AMF may obtain, through an NRF, a corresponding fully qualified domain name (FQDN) of the N11/N16 interface of an SMF+PGW-C for each FQDN for the S5/S8 interface of the SMF+PGW-C included in the received message.

Step 3a. The AMF may, when a CAG ID(s) is included in the message received in step 2, add the CAG ID(s) to an allowed CAG list included in subscriber information of the UE.

Alternatively, when it is identified, based on the message received in step 2, that the UE performs a handover from a CSG cell to a CAG cell, the AMF may add one or more of CAG IDs supported by the target cell to an allowed CAG list included in subscriber information of the UE instead of performing access control.

The AMF may transmit a subscription information update (subscription update) message transmitted to a UDM module. The subscription information update (subscription update) message may include an allowed CAG list of the UE for a corresponding PLMN together with a subscription permanent identifier (SUPI). The allowed CAG list may include one or more of CAG IDs included in the message received in step 2.

Step 3b. When the subscription information update (subscription update) message is received, the UDM module may perform update for a UDR. The UDM module may transmit a response message to the AMF when the update is performed.

Step 5. The AMF may generate a packet data network (PDN) connection included in the UE context received in step 2, and perform a procedure of generating packet data unit (PDU) session context(s) for each SMF+PGW-C.

When the AMF is unable to support an S-NSSAI (i.e., an S-NSSAI associated with a PDU session) received from the SMF+PGW-C, the AMF may select another AMF and transmit the UE context (i.e., the AMF may be changed).

Step 6. The target AMF may transmit a handover request message to a target gNB (i.e., NG-RAN). The handover request message may include the following information:
Source to Target Transparent Container: A transparent container transmitted by a source base station to a target base station;
Allowed NSSAI: Allowed slice information;
PDU session-related information; and
Allowed CAG List: When the AMF determines that the target cell is a CAG cell, an allowed CAG list for the UE may be included. Corresponding information may be included and transmitted in a mobility restriction list.

Step 7. When the target cell is a CAG cell at the time of a handover between systems in evolved-universal terrestrial radio access network (E-UTRAN), the target gNB (i.e., target NG-RAN node) is required to include a cell CAG list (i.e., CAG ID(s) supported by a cell) in a handover request acknowledge message. If an allowed CAG list is included in the message received in step 6, the target gNB may not include a cell CAG list in the handover request acknowledge message.

Step 8a. When a CAG ID(s) (e.g., a cell CAG list) is included in the message received in step 2 and the UE performs a handover from an EPS to a 5GS, the AMF may add the CAG ID(s) to an allowed CAG list included in subscriber information of the UE.

The AMF may transmit a subscription information update (subscription update) message transmitted to the UDM module. The subscription information update message may include an allowed CAG list of the UE for a corresponding PLMN together with a SUPI. The allowed CAG list may include one or more of CAG IDs included in the message received in step 2.

Step 8b. When the subscription information update message is received, the UDM module may update the UDR. The UDM module may transmit a response message to the AMF when the update is performed.

Step 9. The remaining handover procedure may be performed. After a handover to the target gNB is executed, the UE may perform a registration procedure.

Step 9a. When in the UE registration procedure, an N2 message received by the AMF from the NG-RAN includes a cell CAG list and the UE has moved from an EPS to a 5GS (e.g., a registration request message includes information indicating the movement), the AMF may update the allowed CAG list included in the subscriber information of the UE.

The AMF may transmit a subscription information update message transmitted to the UDM module. The subscription information update message may include an allowed CAG list of the UE for a corresponding PLMN together with a SUPI. The allowed CAG list may include one or more of CAG IDs included in the message received in step 2.

Step 9b. When the subscription information update message is received, the UDM module may update the UDR. The UDM module may transmit a response message to the AMF when the update is performed.

Step 10. The remaining handover procedure may be performed.

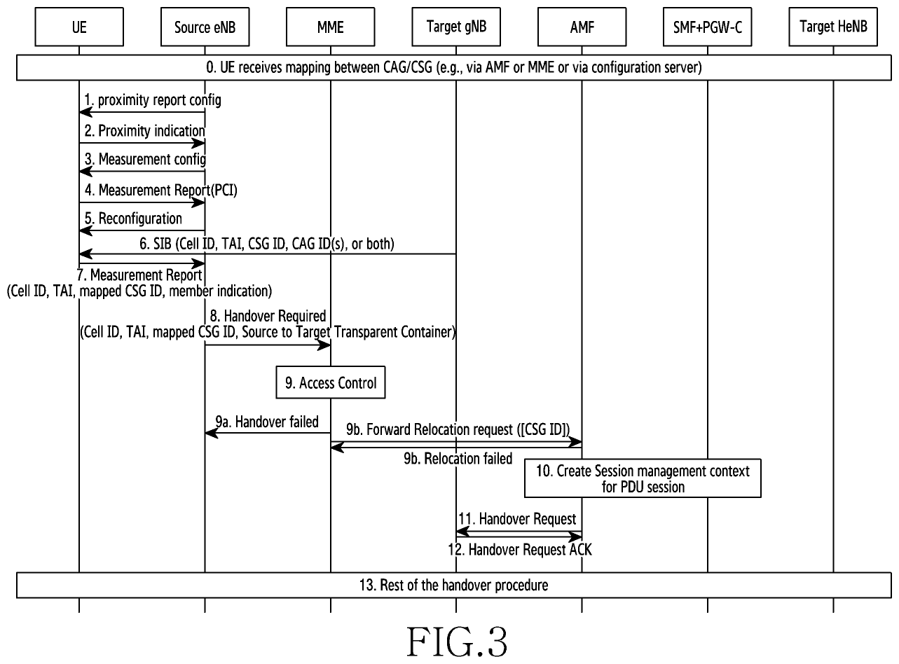

FIG. 3 is a diagram illustrating a method of, when a UE performs a handover from an EPS to a 5GS, selecting a target CAG cell supporting one or more of CAG IDs allowed to the UE, based on mapping information between a CSG ID and a CAG ID, according to an embodiment.

The length of a CAG ID may be expressed by a 32-bit string. In addition, the length of a CSG ID may be expressed by a 27-bit string.

Step 0. A UE may receive, from an AMF, and store mapping configuration information between a CAG ID and a CSG ID in a 5GS registration procedure, receive, from an MME, and store same from an attach procedure, receive, through a configuration server (e.g., open mobile alliance (OMA) device management (DM)), and store same, or store same as configuration information.

Alternatively, the UE may receive, from the AMF, and store a rule of mapping a CAG ID to a CSG ID (mapping rule from CAG ID to CSG ID) and/or a rule of mapping a CSG ID to a CAG ID (mapping rule from CSG ID to CAG ID) in a 5GS registration procedure, receive, from the MME, and store same from an attach procedure, receive, through the configuration server (e.g., OMA DM), and store same, or store same as configuration information through other methods. The UE may derive a CSG ID (e.g., mapped CSG ID) corresponding to a CAG ID (e.g., a CAG ID included in an allowed CAG list and/or a CAG ID included in a SIB message received from a base station) by using the mapping rule from CAG ID to CSG ID with respect to the CAG ID. The UE may derive a CAG ID (e.g., mapped CAG ID) corresponding to a CSG ID (e.g., a CSG ID included in an allowed CSG list and/or a CSG ID included in a SIB message received from a base station) by using the mapping rule from CSG ID to CAG ID with respect to the CSG ID.

The mapping rule from CAG ID to CSG ID and/or the mapping rule from CSG ID to CAG ID may be configured for each PLMN ID (i.e., the rule may differ for each PLMN) or configured regardless of a PLMN (i.e., the rule is same for all PLMNs). In addition, when the UE derives a mapped CSG ID for a CAG ID by using the mapping rule from CAG ID to CSG ID in a PLMN and transmits the derived CSG ID to a network, the network (e.g., AMF or NG-RAN) may use the mapping rule from CSG ID to CAG ID enabling determination of the original CAG ID from the mapped CSG ID and derive the CAG ID through the mapping rule. Similarly, when the UE derives a mapped CAG ID for a CSG ID by using the mapping rule from CSG ID to CAG ID in a PLMN and then transmits same to a network, the network (e.g., MME or eNB) may use the mapping rule from CAG ID to CSG ID enabling determination of the original CSG ID from the mapped CAG ID and derive the CSG ID through the mapping rule.

The UE may receive, from the MME or AMF, and store an allowed CAG list (a list including allowed CAG ID(s) for each PLMN, e.g., the list may be a form such as an allowed CAG list for PLMN ID1=CAG ID A, CAG ID B, or an allowed CAG list for PLMN ID2=CAG ID X, CAG ID Y) and valid period information, receive, through the configuration server (e.g., OMA DM), and store same, or store same as configuration information.

The UE may receive, from the MME, and store an allowed CSG list (a list including allowed CSG ID(s) for each PLMN, e.g., the list may be a form such as an allowed CSG list for PLMN ID1=CSG ID A, CSG ID B, or an allowed CSG list for PLMN ID2=CSG ID X, CSG ID Y) and valid period information, receive, through the configuration server (e.g., OMA DM), and store same, or store same as configuration information.

Step 1. A source eNB configures information for a proximity indication control for the UE. The source eNB may transmit a proximity report configuration information to the UE.

Step 2. When it is determined, through a cell search procedure, that the UE may exist near a CAG cell (e.g., a cell belonging to a base station of a 5GS) and/or a CSG cell, the UE may transmit a proximity indication including the RAT and frequency of the corresponding cell to the source eNB.

Step 3. When there is no measurement configuration for the frequency and/or RAT received in step 2, the source eNB may transmit a measurement configuration to the UE so that the UE performs a measurement for the frequency and/or RAT.

Step 4. The UE may transmit a measurement report including a physical cell ID (PCI) to the source eNB.

Step 5. The source eNB may transmit, to the UE, a configuration for acquiring system information of the corresponding cell (e.g., performing SI acquisition).

Step 6. The UE may receive a SIB message from the target cell to obtain system information. The SIB message may include a cell ID (e.g., a cell global identifier (CGI)), a tracking area identifier (TAI), this is configured by a mobile network code (MNC), mobile country code (MCC), and tracking area code (TAC)), a CSG ID, a CAG ID, or a CSG ID and CAG ID.

Step 7. When a CAG ID(s) is included in the SIB message received in step 6, the UE may derive a mapped CSG ID corresponding to the received CAG ID(s), based on the mapping information between a CAG ID and a CSG ID obtained in step 0.

If the mapping information between a CAG ID and a CSG ID includes information indicating use of the same CSG ID value being required, the UE may derive a mapped CSG ID configured to have the same CSG ID value as that of the CAG ID.

Alternatively, instead of the mapping information between a CAG ID and a CSG ID (e.g., if the mapping information does not exist or a mapping rule from CAG ID to CSG ID is introduced/used instead of the mapping information), the UE may derive a mapped CSG ID corresponding to the received CAG ID(s), based on a rule of mapping a CAG ID to a CSG ID (mapping rule from CAG ID to CSG ID).

Alternatively, if a CSG ID is included in the SIB message received from the target cell, the UE may use same without change (e.g., if a CSG ID is included in an SIB message transmitted by a gNB or NR cell).

When the UE identifies, based on the information obtained in step 0, that the CAG ID or CSG ID included in the information received in step 6 (i.e., the system information of the target cell) is allowed for the UE, the UE may include, in a measurement report, a member indication indicating that the target cell (i.e., a cell identified by a cell ID included in the measurement report) is a CSG member cell.

For example, if a CAG ID(s) is included in the message received in step 6, when a PLMN ID (e.g., this is derived through the TAI in the message received in step 6) of the target cell is not included in the allowed CAG list or any of the CAG ID(s) are not included in the allowed CAG list, the UE may determine that it is impossible to move to the target cell and configure a member indication as non-member.

For example, if a CAG ID(s) is included in the message received in step 6 and the allowed CAG list is not stored, when a PLMN ID (e.g., this is derived through the TAI in the message received in step 6) of the target cell is not included in the allowed CSG list or any of CSG ID(s) derived for the CAG ID(s) are not included in the allowed CSG list, the UE may determine that it is impossible to move to the target cell and configure a member indication as non-member.

The UE may transmit a measurement report including a cell ID, a TAI, a CSG ID, and a member indication to the source eNB, based on the information received in step 6. Step 8. The source eNB may transmit, to the MME, a handover required message (a source to target transparent container, a cell ID, a mapped CSG ID, and a target TAI).

The source eNB may determine, as a target cell, one of the cells for which a member indication of the message received from the UE in step 7 indicates member, and include an ID of the cell in a handover required message.

Step 9. The MME may perform an access control, based on the CSG ID.

The MME may perform step 9b when the received CSG ID is included in UE subscriber information, and it is determined that the CSG ID is valid according to the UE subscriber information.

Alternatively, the MME may be configured not to perform an access control when the MME has received the CSG ID, but the UE moves from an EPS to a 5GS (e.g., the target cell is associated with a base station (e.g., a gNB) connected to a 5G core).

In this case, when the MME receives the message of step 8 including a CSG ID and the UE moves from an EPS to a 5GS, the MME may not perform an access control and perform step 9b.

9a. When there is no PLMN ID (e.g., this is derived from the message received in step 8) of the target cell in UE subscriber information (e.g., the allowed CSG list), any of CSG ID(s) (CSG ID included in the message received in step 8) for the target cell are not included in the UE subscriber information, or the CSG ID is not currently valid (e.g., a valid period for the CSG ID expires), the MME may transmit, to the source eNB, a message indicating that the handover has failed.

9b. When the received CSG ID is included in UE subscriber information and it is determined that the CSG ID is valid according to the UE subscriber information, the MME may perform a handover procedure.

The MME may transmit a forward relocation request message to the target AMF. The forward relocation request message may include MME UE context, a source to target transparent container, a cell ID (e.g., a target gNB identity), a CSG ID, a CSG membership indication, or a target TAI.

When a CSG ID is included in the received forward relocation request message, the AMF may determine that the target cell is a CAG cell.

The AMF may derive an associated CAG ID(s) (i.e., a CAG ID(s) supported by the target cell), based on mapping information between a CSG ID and a CAG ID.

The mapping information between a CSG ID and a CAG ID may be stored as configuration information or included in the UE subscriber information.

Alternatively, if the mapping information does not exist or a mapping rule from CSG ID to CAG ID is introduced/used instead of the mapping information, when a CSG ID is included in the received forward relocation request message, the AMF may derive a CAG ID corresponding to the CSG ID by using the mapping rule from CSG ID to CAG ID stored as configuration information. The AMF may derive an associated CAG ID(s) (i.e., a CAG ID(s) supported by the target cell), based on the mapping rule from CSG ID to CAG ID.

The UE may store, in the UE subscriber information, an allowed CAG list (a list including allowed CAG ID(s) for each PLMN, e.g., the list may be a form such as an allowed CAG list for PLMN ID1=CAG ID A, CAG ID B, or an allowed CAG list for PLMN ID2=CAG ID X, CAG ID Y) and valid period information.

When there is no PLMN ID of the target cell in UE subscriber information (e.g., the allowed CAG list), any of CAG ID(s) for the target cell are not included in the UE subscriber information, or the CAG ID is not currently valid (e.g., a valid period for the CAG ID expires), the AMF may transmit a reject message for the request message from the MME to the MME.

The AMF may convert the received MME UE context into the 5GS UE context.

The AMF may obtain, through an NRF, a corresponding FQDN of the N11/N16 interface of an SMF+PGW-C for each FQDN for the S5/S8 interface of the SMF+PGW-C included in the received message.

When the received CSG ID is not included in the UE subscriber information (i.e., the received CSG ID is not included in CAG ID(s) allowed to the UE) or it is determined that the CSG ID is not valid according to the UE subscriber information, the AMF may transmit, to the MME, a response message including an indicator indicating that relocation has failed. When the response message indicating a failure is received from the AMF, the MME may stop the handover procedure.

Step 10. The AMF may perform a procedure of generating a PDN connection included in the UE context received in step 9b and generating PDU session context(s) for each SMF+PGW-C.

When the AMF is unable to support an S-NSSAI (i.e., an S-NSSAI associated with a PDU session) received from the SMF+PGW-C, the AMF may select another AMF and transmit the UE context (i.e., the AMF may be changed).

Step 11. The target AMF may transmit a handover request message to the NG-RAN. The handover request message may include the following information:
Source to Target Transparent Container: A transparent container transmitted by a source base station to a target base station;
Allowed NSSAI: Allowed slice information;
PDU session-related information; and
Allowed CAG List: When the AMF determines that the target cell is a CAG cell, an allowed CAG list for the UE may be included.

Step 12. When the target cell is a CAG cell at the time of a handover between systems in E-UTRAN, a target gNB (i.e., target NG-RAN node) is required to include a cell CAG list (i.e., CAG ID(s) supported by a cell) in a handover request acknowledge message, and the AMF considers that the included information is information associated with the target cell.

When an allowed CAG list is included in the message received in step 11, the target gNB may not include a cell CAG list in the handover request acknowledge message.

Step 13. The remaining handover procedure may be performed.

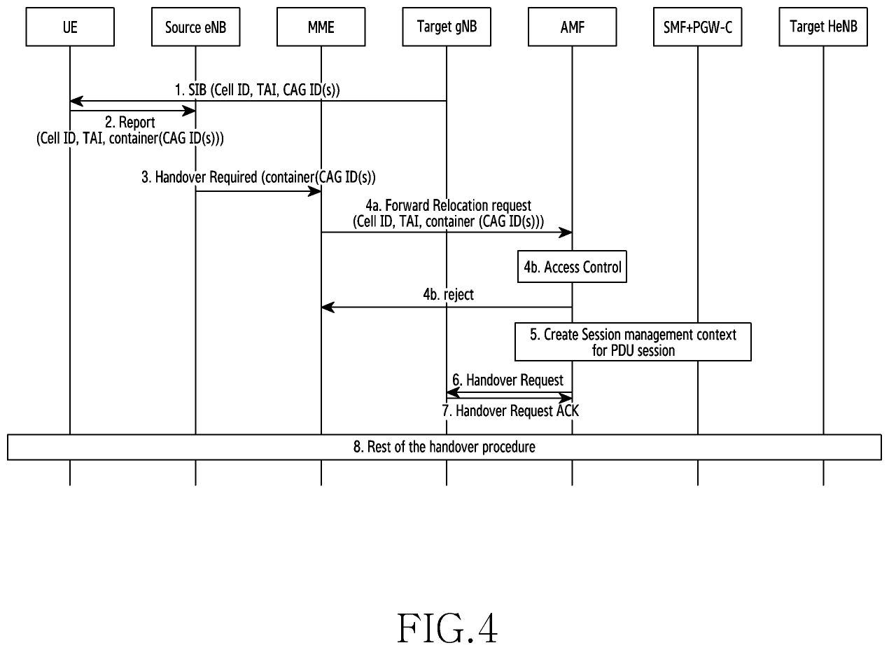

FIG. 4 is a diagram illustrating a method of performing an access control, based on a CAG ID of a target base station when a UE performs a handover from an EPS to a 5GS, according to an embodiment.

Step 1. A UE may receive a SIB message from a target cell to obtain system information. The SIB message may include a cell ID (e.g., a CGI), a TAI, this is configured by a MNC, MCC, and TAC), a CAG ID, or a CSG ID.

Step 2. The UE may transmit a report including a cell ID, a TAI, and a transparent container to a source eNB, based on the information received in step 1.

A CAG ID(s) may be included and transmitted in the transparent container or separately transmitted.

Step 3. The source eNB may transmit a handover required message including a source to target transparent container, a cell ID, and a TAI to an MME.

The source eNB may, if a transparent container or CAG ID(s) is received from the UE or a CAG ID(s) for the target cell is obtained from a neighboring base station or OAM, transmit the ID after directly including the ID in the handover required message or including the ID in a separate transparent container. Alternatively, the source eNB may derive a mapped CSG ID(s) corresponding to the CAG ID(s) received from the UE, based on configuration information. In this case, the source eNB may, if a transparent container or CAG ID(s) is received from the UE or a CAG ID(s) of the target cell is obtained from a neighboring base station or OAM, transmit the mapped CSG ID(s) after including same in the handover required message.

Alternatively, the source eNB may, if a transparent container or CAG ID(s) is received from the UE or a CAG ID(s) of the target cell is obtained from a neighboring base station or OAM, include the CAG ID(s) in the source to target transparent container of a handover required message transmitted to the MME.

Alternatively, if a transparent container or a CAG ID(s) of a candidate target cell is received from the UE, or a CAG ID(s) for a candidate target cell is obtained from a neighboring base station or OAM, the source eNB may determine, as a target cell, a candidate target cell for which the CAG ID(s) for the candidate target cell (i.e., a CAG ID(s) supported by the candidate target cell) includes at least one of CAG ID(s) derived for a serving cell (e.g., if a serving cell of the UE is a CSG cell, the source eNB may derive a corresponding CAG ID(s) for a CSG ID(s) supported by the serving cell). The source eNB may accept the corresponding cell as a target cell and transmit a handover required message including a source to target transparent container, a cell ID, and a TAI to the MME.

Step 4a. The MME may transmit a forward relocation request message to a target AMF. The forward relocation request message may include MME UE context, a source to target transparent container, a transparent container or CAG ID(s), a cell ID (e.g., a target gNB identity), or a target TAI.

If the MME receives a transparent container in step 3, corresponding information may be included in the forward relocation request message.

In addition, if the MME receives a CAG ID(s) in step 3, corresponding information may be included in the forward relocation request message. If a CAG ID(s) is included in the message received in step 3, when the CAG ID(s) is not allowed by current subscription information of the UE (e.g., any of the CAG ID(s) received in step 3 are not included in CAG ID(s) allowed for the UE or any of the CSG ID(s) corresponding to the CAG ID(s) received in step 3 are not included in CSG ID(s) allowed for the UE), the MME may transmit a handover reject (or failure) message to the source eNB. When the CAG ID(s) received in step 3 is allowed by the current subscription information of the UE, the MME may transmit a forward relocation request message to the AMF.

If a CSG ID(s) is included in the message received in step 3, when the CSG ID(s) is not allowed by current subscription information of the UE (e.g., any of the CSG ID(s) received in step 3 are not included in CSG ID(s) allowed for the UE), the MME may transmit a handover reject (or failure) message to the source eNB. When the CSG ID(s) received in step 3 is allowed by the current subscription information of the UE, the MME may transmit a forward relocation request message to the AMF.

The initial AMF may convert the received MME UE context into 5GS UE context.

The initial AMF may obtain, through an NRF, a corresponding FQDN of the N11/N16 interface of the SMF+PGW-C for each FQDN for the S5/S8 interface of the SMF+PGW-C included in the received message.

Step 4b. If a CAG ID(s) is included in the message received in step 4a, the AMF may perform an access control, based on an allowed CAG list included in UE subscriber information.

For example, if a CAG ID(s) is included in the message received in step 4a, when a

PLMN ID (e.g., this is derived through the TAI in the message received in step 4b) of the target cell is not included in the allowed CAG list or any of the CAG ID(s) are not included in the allowed CAG list, or when a valid period expires, the AMF may transmit, to the MME, a message that rejects a handover to the target cell.

Step 5. The AMF may perform a procedure of generating a PDN connection included in the UE context received in step 4a and generating PDU session context(s) for each SMF+PGW-C.

When the AMF is unable to support an S-NSSAI (i.e., an S-NSSAI associated with a PDU session) received from the SMF+PGW-C, the AMF may select another AMF and transmit the UE context (i.e., the AMF may be changed).

Step 6. The target AMF transmits a handover request message to a target gNB (i.e., NG-RAN). The handover request message may include the following information:
Source to Target Transparent Container: A transparent container transmitted by a source base station to a target base station;
Allowed NSSAI: Allowed slice information;
PDU session-related information; and
Allowed CAG List: When the AMF determines that the target cell is a CAG cell, an allowed CAG list for the UE may be included. Corresponding information may be included and transmitted in a mobility restriction list.

Step 7. When the target cell is a CAG cell at the time of a handover between systems in E-UTRAN, the target gNB (i.e., target NG-RAN node) is required to include a cell CAG list (i.e., CAG ID(s) supported by a cell) in a handover request acknowledge message, and the AMF considers that the included information is information associated with the target cell.

When any of the CAG ID(s) included in the allowed CAG list received in step 6 are not included in the CAG ID(s) supported by the target cell (e.g., this may be identified based on the information included in the source to target transparent container received in step 6), the target gNB may transmit a handover request reject message to the AMF. When the handover request reject message is received, the AMF may transmit, to the MME, a message indicating that the handover has failed and, when the corresponding message is received, the MME may transmit, to the source eNB, a message indicating that the handover has failed. If an allowed CAG list is included in the message received in step 6, the target gNB may not include a cell CAG list in a handover request acknowledge message.

Step 8. The remaining handover procedure may be performed.

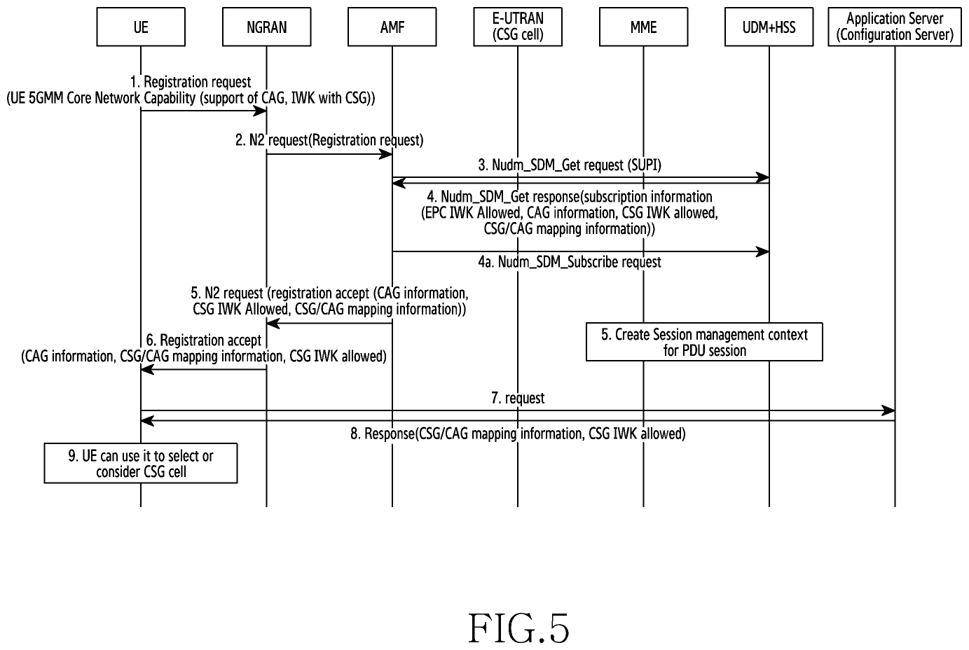

FIG. 5 is a diagram illustrating a registration procedure of a UE, according to an embodiment.

Step 1. A UE may transmit a registration request message to an NG-RAN and an AMF.

The registration request message may include information relating to whether a CAG is supported or whether interworking with a CSG cell is supported in a UE 5GMM core network capability.

Step 2. The NG-RAN may transmit the registration request message to an AMF.

Step 3. The AMF may request subscriber information of the UE from a UDM+HSS. If the UE is a supported UE, the AMF may include a parameter that requests information for interworking with a CSG cell.

Step 4. The UDM+HSS may include, in a response message transmitted to the AMF, CSG/CAG mapping information (i.e., mapping information which may derive a CSG ID, based on a CAG ID, and this may exist for each PLMN ID) or CSG IWK allowed information (whether interworking with a CSG cell is allowed, and this may exist for each PLMN) for each PLMN.

If the UE indicates that “EPC IWK allowed” is not allowed, the UDM+HSS may not include CSG IWK Allowed and/or CSG/CAG mapping information.

If the UE indicates that “CSG IWK allowed” is not allowed, the UDM+HSS may not include CSG/CAG mapping information.

Step 4a. The AMF may transmit, to the UDM+HSS, a subscription request message that requests a notification when the UE subscriber information is changed.

Step 5. The AMF may include a registration accept in an N2 message and transmit same to the NG-RAN.

A registration accept message may include CSG IWK Allowed, CSG/CAG mapping information, or CAG information.

Step 6. The UE may receive a registration accept message included in a message received from the NG-RAN.

Steps 7-8. The UE may receive, from an application server (or configuration server), CSG/CAG mapping information (i.e., mapping information which may derive a CSG ID, based on a CAG ID, and this may exist for each PLMN ID) or CSG IWK allowed information (whether interworking with a CSG cell is allowed, and this may exist for each PLMN) for each PLMN.

Step 9. The UE may, when CSG/CAG mapping information is included together with CAG information (i.e., PLMN IDs and a list of allowed CAG ID(s) for one or more PLMNs) in step 6 or step 8, the UE may derive a permitted CSG list (i.e., a list including allowed CSG ID(s) for each PLMN) from the CAG information and store same.

When CSG IWK allowed is received together with CAG information, the UE may derive a permitted CSG list (i.e., a list including allowed CSG ID(s) for each PLMN) from the CAG information by using, as a CSG ID, the same value as that of a CAG ID included in the CAG information, and store same.

The UE may perform cell selection or reselection for a cell belonging to an eNB, based on an allowed CSG ID(s) derived from CSG/CAG mapping information and a PLMN ID.

At the time of performing cell reselection, when a SIB message includes a CSG ID, a cell ID, or a TAI, if the CSG ID is allowed according to the derived permitted CSG list (i.e., the CSG ID included in the SIB message is included in a permitted CSG list for a corresponding PLMN (i.e., this is derived through the TAI included in the SIB message)), the UE may preferentially select a corresponding CSG cell.

At the time of performing a measurement for a handover, when a SIB message includes a CSG ID, a cell ID, or a TAI, if the CSG ID is allowed according to the derived permitted CSG list (i.e., the CSG ID included in the SIB message is included in a permitted CSG list for a corresponding PLMN (i.e., this is derived through the TAI included in the SIB message)), the UE may preferentially consider a corresponding CSG cell (e.g., a connection is established through the cell).

When a permitted CSG list is received from a configuration server (e.g., an OMA DM server) through a PDN connection in an EPS, and when CSG/CAG mapping information is stored, the UE may derive and store an allowed CAG list for a corresponding PLMN.

The UE may perform cell selection or reselection, based on an allowed CAG list derived from CSG/CAG mapping information and a PLMN ID. When a CAG ID(s) and/or a PLMN ID included in an SIB message received from a gNB is included in the allowed CAG list, the UE may consider selecting a corresponding cell (e.g., a connection is established through the cell).

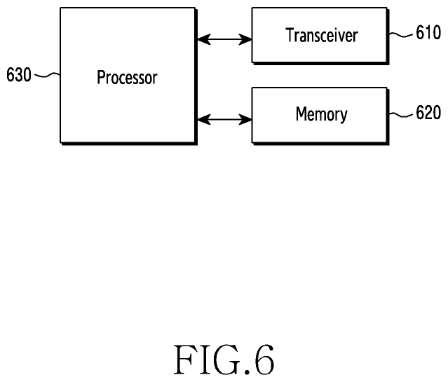

FIG. 6 is a diagram illustrating a structure of a UE, according to an embodiment.

As illustrated in FIG. 6, a UE may include a transceiver 610, a memory 620, and a processor (or controller) 630. The processor (or controller) 630, the transceiver 610, and the memory 620 of the UE may operate according to the above-described communication methods of the UE. Components of the UE are not limited to the above-described example. For example, the UE may include a larger or smaller number of components than the above-described components. In addition, the processor 630, the transceiver 610, and the memory 620 may be implemented in the form of a single chip.

The transceiver 610 refers to a UE receiver and a UE transmitter as a whole, and may transmit/receive signals with base stations or network entities. The signals transmitted/received with the base station may include control information and data. To this end, the transceiver 610 may include a radio frequency (RF) transmitter configured to up-convert and amplify the frequency of transmitted signals, an RF receiver configured to low-noise-amplify received signals and down-convert the frequency thereof, and the like. However, this is only an embodiment of the transceiver 610, and the components of the transceiver 610 are not limited to the RF transmitter and the RF receiver.

Also, the transceiver 610 may include wired/wireless transceivers, and may include various components for transmitting/receiving signals.

In addition, the transceiver 610 may receive signals through a radio channel, output the same to the processor 630, and transmit signals output from the processor 630 through the radio channel.

Furthermore, the transceiver 610 may receive communication signals, output same to a processor, and transmit signals output from the processor to a network entity through a wired/wireless network.

The memory 620 may store programs and data necessary for operations of the UE. In addition, the storage 620 may store control information or data included in signals acquired by the UE. The memory 620 may include storage media such as a read only memory (ROM), a random access memory (RAM), a hard disk, a compact disc (CD)-ROM, a digital versatile disc (DVD), or a combination of storage media.

The processor (or controller) 630 may control a series of processes such that the UE can operate according to the above-described embodiments of the disclosure. The processor 630 may include one or more processors. For example, the processor 630 may include a communication processor (CP) which performs control for communication and an application processor (AP) which controls upper layers such as application programs.

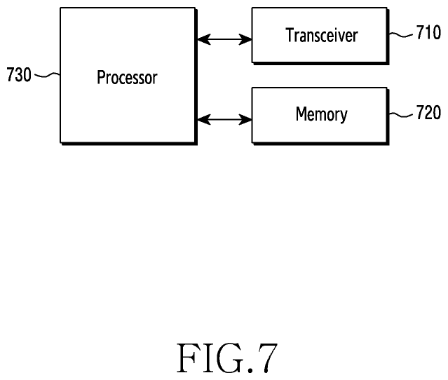

FIG. 7 is a diagram illustrating a structure of a network entity, according to an embodiment.

As illustrated in FIG. 7, a network entity may include a transceiver 710, a memory 720, and a processor (or controller) 730. The processor (or controller) 730, the transceiver 710, and the memory 720 of the network entity may operate according to the above-described communication methods of the network entity. However, components of the network entity are not limited to the above-described example. For example, the network entity may include a larger or smaller number of components than the above-described components. In addition, the processor 730, the transceiver 710, and the memory 720 may be implemented in the form of a single chip. The network entity may include NFs, such as an AMF, a SMF, a PCF, a network exposure function (NEF), a UDM module, a UDR, a UPF, as described above. Also, the network entity may include a base station.

The transceiver 710 refers to a network entity receiver and a network entity transmitter as a whole, and may transmit/receive signals with UEs or other network entities. The transmitted/received signals may include control information and data. To this end, the transceiver 710 may include an RF transmitter configured to up-convert and amplify the frequency of transmitted signals, an RF receiver configured to low-noise-amplify received signals and down-convert the frequency thereof, and the like. However, this is only an embodiment of the transceiver 710, and the components of the transceiver 710 are not limited to the RF transmitter and the RF receiver. The transceiver 710 may include wired/wireless transceivers, and may include various components for transmitting/receiving signals.

In addition, the transceiver 710 may receive signals through a communication channel (e.g., a radio channel), output the same to the processor 730, and transmit signals output from the processor 730 through the communication channel.

Furthermore, the transceiver 710 may receive communication signals, output same to a processor, and transmit signals output from the processor to UEs or network entities through a wired/wireless network.

The memory 720 may store programs and data necessary for operations of the network entity. In addition, the memory 720 may store control information or data included in signals transmitted/received by the network entity. The memory 720 may include storage media such as a ROM, a RAM, a hard disk, a CD-ROM, a DVD, or a combination of storage media.

The processor (or controller) 730 may control a series of processes such that the network entity can operate according to the above-described embodiments of the disclosure. The processor 730 may include one or more processors.

It should be noted that the configuration diagrams, illustrative diagrams of control/data signal transmission methods, and illustrative diagrams of operation procedures as illustrated in FIG. 1 to FIG. 7 are not intended to limit the scope of protection of the disclosure. That is, all the constituent units or operation steps shown in FIG. 1 to FIG. 7 should not be construed as essential elements for implementing the disclosure, and even when including only some of the elements, the disclosure may be implemented without impairing the true nature of the disclosure.

The above-described operations of the embodiments may be implemented by providing any unit of a device with a memory device storing corresponding program codes. That is, a controller in the device may perform the above-described operations by reading and executing the program codes stored in the memory device by means of a processor or CPU.

Various units or modules of an entity or terminal device set forth herein may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a ROM, an electrically erasable programmable ROM (EEPROM), a magnetic disc storage device, a CD-ROM, DVDs, or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

Herein, an element is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

In the drawings in which methods of the disclosure are described, the order of the description does not always correspond to the order in which steps are performed, and the order relationship between the steps may be changed or the steps may be performed in parallel. In addition, in the drawings in which the embodiments of the disclosure are described, some of the elements may be omitted and only the other elements may be included without departing from the essential spirit and scope of the disclosure.

In the embodiments of the disclosure, some or all of the contents of each embodiment may be implemented in combination without departing from the essential spirit and scope of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method of a user equipment (UE) in a wireless communication system, the method comprising:
receiving, from an evolved node B (eNB), configuration information for acquiring system information (SI) of a closed access group (CAG) cell of a gnodeB (gNB);
receiving, from the CAG cell, a system information block (SIB); and
transmitting, to the eNB, a measurement report comprising information related to an identifier (ID) of the CAG cell based on the SIB.

2. The method of claim 1, wherein the information related to the ID of the CAG cell comprises at least one of a CAG ID of the CAG cell or a mapped closed subscriber group (CSG) ID corresponding to the CAG ID.

3. The method of claim 2, further comprising acquiring the CAG ID or the mapped CSG ID based on at least one of mapping information between the CAG ID and the mapped CSG ID or a mapping rule for deriving the mapped CSG ID from the CAG ID.

4. The method of claim 3, further comprising identifying whether the CAG cell is allowed for the UE based on the CAG ID or the mapped CSG ID based on an allowed CAG list including an allowed CAG ID,
wherein the measurement report comprises an indication indicating whether the CAG cell is allowed for the UE.

5. The method of claim 1, wherein the CAG cell is discovered by a cell search procedure of the UE.

6. A method of an access and mobility management function (AMF) entity in a wireless communication system, the method comprising:
receiving, from a mobility management entity (MME), a forward relocation request message including a closed access group (CAG) identifier (ID) for a CAG cell of a gnodeB (gNB) in a source to target transparent container; and
performing an access control based on the CAG ID.

7. The method of claim 6, wherein performing the access control comprises identifying whether the CAG ID is included in an allowed CAG list, and
wherein the allowed CAG list is included in subscription information.

8. The method of claim 7, further comprising performing handover in case that the CAG ID is included in the allowed CAG list.

9. The method of claim 6, further comprising:
updating an allowed CAG list of a user equipment (UE) by including the CAG ID; and
transmitting, to a unified data management (UDM) module, a subscription information update message comprising the updated allowed CAG list.

10. The method of claim 6, further comprising transmitting, to a UE, at least one of mapping information between the CAG ID and a mapped closed subscriber group (CSG) ID or a mapping rule for deriving the mapped CSG ID from the CAG ID.

11. A user equipment (UE) in a wireless communication system, the UE comprising:
a transceiver; and
at least one controller coupled with the transceiver, the at least one controller being configured to:
receive, from an evolved node B (eNB), configuration information for acquiring system information (SI) of a closed access group (CAG) cell of a gnodeB (gNB);
receive, from the CAG cell, a system information block (SIB); and
transmit, to the eNB, a measurement report comprising information related to an identifier (ID) of the CAG cell based on the SIB.

12. The UE of claim 11, wherein the information related to the ID of the CAG cell comprises at least one of a CAG ID of the CAG cell or a mapped closed subscriber group (CSG) ID corresponding to the CAG ID.

13. The UE of claim 12, wherein the at least one controller is further configured to:
acquire the CAG ID or the mapped CSG ID based on at least one of mapping information between the CAG ID and the CSG ID or a mapping rule for deriving the mapped CSG ID from the CAG ID.

14. The UE of claim 13, wherein the at least one controller is further configured to identify whether the CAG cell is allowed for the UE based on the CAG ID or the mapped CSG ID based on an allowed CAG list including an allowed CAG ID, and
wherein the measurement report comprises an indication indicating whether the CAG cell is allowed for the UE.

15. The UE of claim 13, wherein the CAG cell is discovered by a cell search procedure of the UE.

16. An access and mobility management function (AMF) entity in a wireless communication system, the AMF entity comprising:
a transceiver; and
at least one controller coupled with the transceiver, the at least one controller being configured to:
receive, from a mobility management entity (MME), a forward relocation request message including a closed access group (CAG) identifier (ID) for a CAG cell of a gnodeB (gNB) in a source to target transparent container; and
perform an access control based on the CAG ID.

17. The AMF entity of claim 16, wherein the at least one controller is further configured to identify whether the CAG ID is included in an allowed CAG list, and
wherein the allowed CAG list is included in subscription information.

18. The AMF entity of claim 17, wherein the at least one controller is further configured to perform handover in case that the CAG ID is included in the allowed CAG list.

19. The AMF entity of claim 16, wherein the at least one controller is further configured to:
update an allowed CAG list of a user equipment (UE) by including the CAG ID, and
transmit, to a unified data management (UDM) module, a subscription information update message including the updated allowed CAG list.

20. The AMF entity of claim 16, wherein the at least one controller is further configured to:
transmit, to a UE, at least one of mapping information between the CAG ID and a mapped closed subscriber group (CSG) ID or a mapping rule for deriving the mapped CSG ID from the CAG ID.
